(19) United States
(12) Patent Application Publication
(10) Pub. No.: US 2005/0077257 A1
(43) Pub. Date: Apr. 14, 2005

(54) Arrangement for merchandise display prongs

(76) Inventors: Bengt Ahlund, Sollentuna (SE); Marten Sjoberg, Stockholm (SE)

Correspondence Address: SUGHRUE MION, PLLC, 2100 PENNSYLVANIA AVENUE, N.W., SUITE 800, WASHINGTON, DC, 20037, US

(21) Appl. No.: 10/503,896

(22) PCT Filed: Jan. 24, 2003
(86) PCT No.: PCT/SE03/00122

(30) Foreign Application Priority Data
Feb. 21, 2002 (SE) 0200509-8

(51) Int. Cl. B42F 1/00

(52) U.S. Cl. 211/54.1

(57) ABSTRACT

Arrangement for merchandise display prongs intended for displaying merchandise in shops and the like, comprising a cantilever arm (1) for carrying the merchandise and a feed device (4) which is displaceable along the arm and provided with a grip part (6). The feed device is intended to be maneuvered manually in order to displace the merchandise carried by the arm (1) in the forward direction toward its free end for the purpose of bringing about a favorable display of the merchandise. The feed device (4) is spring-preloaded toward the attachment end of the cantilever arm. The arrangement comprises an unrollable spiral spring (9), the spring roll (8) of which is arranged in a seat on that side of the feed device (4) which faces the attachment end of the arm (1). The spring (9) is adapted so as to be unrolled from the spring roll (8) in the direction toward the free end of the arm and to be diverted around a diverting means (12) located in front of the roll in order to allow attachment of the outer end of the spring to the attachment end of the arm (1).

### FIELD OF THE INVENTION

The present invention relates to an arrangement for merchandise display prongs intended for displaying merchandise in shops and the like, comprising a cantilever arm for carrying the merchandise and a feed device which is displaceable along the arm and provided with a grip part and which is intended, when acted on manually, to displace the merchandise carried by the arm in the forward direction toward its free end for the purpose of bringing about a favorable display of the merchandise, and which feed device is spring-preloaded toward the attachment end of the cantilever arm.

### BACKGROUND OF THE INVENTION

There are a large number of merchandise display prongs on the market which are provided with feed devices which are spring-preloaded toward the free end of the prong. The reason for this is that the frontmost item of the merchandise carried by a prong is always to be located as far forward on the prong as possible, even if there are only a few items on the prong.

In some cases, it is unsuitable to use spring-preloaded feed devices, in which case the feed device can instead be provided with a grip part, by means of which the feed device can be displaced forward along the prong for manual feed of the merchandise. An example of such a feed device is described in our Swedish patent application 0103132-7.

In some cases, it is desirable to make the grip part as a grip arm which is located above the prong and extends parallel to this toward the free end of the prong. Such an arm can then be provided with mounting means for a label holder intended to receive labels with information, for example price, relating to the merchandise carried by the merchandise prong. In this connection, it is of utmost importance that such a grip arm with merchandise labels is located in the correct position above the prong and does not project a long way in front of the prong so that it catches on, for example, passing customers.

In order to prevent such a grip arm being pulled out unintentionally or forgotten in the pulled-out position, it has previously been proposed to bring about spring-preloading of the feed device toward the attachment end of the merchandise prong. In this way, it is guaranteed that the grip arm, in the rest position, is always located in its inner end position. This is of course just as necessary in the case of grip arms of the type used in the abovementioned patent application.

In order for spring-preloaded feed arrangements to be of interest commercially, it must be possible for them to be manufactured and mounted in a very cost-effective manner. They must also be easy to maintain.

In arrangements for spring-preloading a feed plate in the direction toward the front end of a merchandise prong, the spring-preloading can be achieved simply by means of an unrollable spiral spring. The spring roll can then be arranged on the rear side of a feed plate interacting with the merchandise, it being possible for the spring to pass through an opening in the plate for fixing of the outer end of the spring to the free end of the prong. The spring roll on the rear side of the plate will then be secured on account of being pressed against the plate by the spring force.

In the case of a feed plate according to the present invention, which it is desired to spring-preload in the opposite direction, that is to say toward the attachment end of the merchandise prong, it is not possible to arrange the spring roll in a corresponding manner on the front side of the feed plate, because it will then interfere with the merchandise on the prong.

### THE OBJECT OF THE INVENTION

One object of the present invention is to provide an arrangement which allows the use of an easily mountable spiral spring roll for preloading a feed plate toward the attachment end of a merchandise prong without the spring roll interfering with the merchandise on the prong.

The invention is based on the insight that this can be achieved by arranging the spring roll on the rear side of the feed device and unrolling the spring in the direction toward the front end of the prong and then diverting the spring so that its front end can be fixed to the attachment end of the prong.

In this connection, an arrangement of the type indicated in the first paragraph is characterized in particular in that the arrangement comprises an unrollable spiral spring, in that the spring roll is arranged in a seat on that side of the feed device which faces the attachment end of the arm, in that the spring is adapted to as to be unrolled from the spring roll in the direction toward the free end of the arm and to be diverted around a diverting means located in front of the roll in order to allow attachment of the outer end of the spring to the attachment end of the arm.

An arrangement of this type achieves inter alia the abovementioned aim of allowing very simple, cost-effective preloading of a feed device toward the attachment end of a merchandise prong without a spring roll forming part of the arrangement interfering with the merchandise on the prong. It is preferred that the spring is unrolled from the upper or lower part of the spring roll and that, after being diverted, it extends toward the attachment end of the arm on the opposite side of the roll. This allows very simple construction.

Furthermore, the spring roll is suitably arranged loosely in its seat and it is held in place under the action of the spring force. This makes possible very simple mounting and simple exchange of the spring, if required.

The diverting means is preferably in the form of a transverse bar in an opening in the feed device, which opening is located in front of the seat of the spring roll, and which bar is arranged in such a way that its front surface is located inside the front surface of the feed device, which front surface interacts with the merchandise on the arm, in order to avoid contact between the spring and the merchandise.

Further features of the invention emerge from the following patent claims.

The invention will be described in greater detail below with reference to the embodiment shown by way of example in accompanying drawings.

### BRIEF DESCRIPTION OF THE DRAWING FIGURES

FIG. 1 shows a perspective view of a merchandise display prong with a feed device according to the invention.

FIGS. 2 and 3 show a slide forming part of the feed device, seen from the front and, respectively, from the rear.

FIG. 4 shows the arrangement according to FIG. 1 from the side and partly in section.

FIG. 5 corresponds to FIG. 4 in a complete side view.

FIG. 6 is a horizontal view of the arrangement according to FIG. 1.

### DETAILED DESCRIPTION OF THE PREFERRED EMBODIMENT

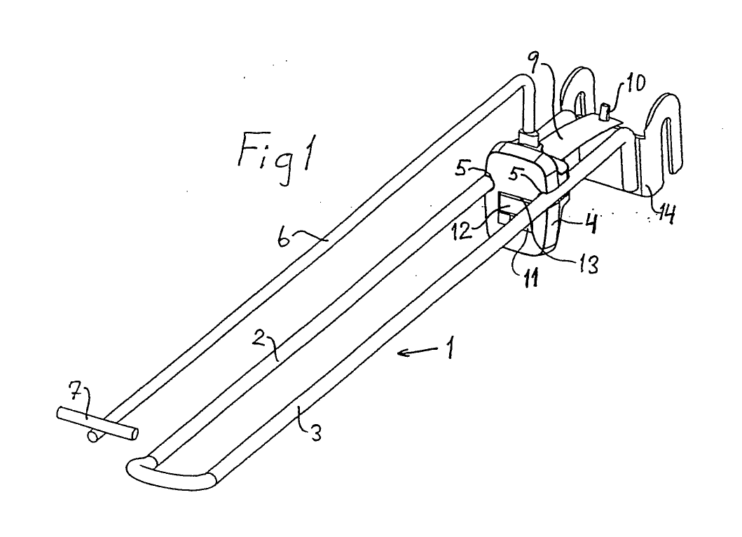

In FIG. 1, reference number 1 designates a merchandise display prong consisting of two wires 2, 3 which are joined at the outer end of the prong to form a U-shaped merchandise prong. The rear ends of the wires are connected to a mounting element 14 for mounting on a supporting structure, for example in the form of a perforated panel or upright.

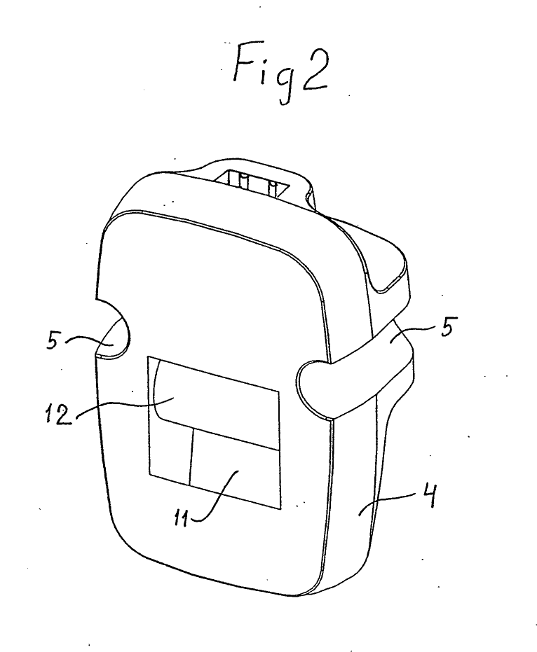

A feed device in the form of a slide 4 is fitted in between the wires. Opposite side edges of the slide 4 are made with guide grooves 5 (see also FIGS. 2 and 3) which interact with the wires 2, 3. Fastened in the top surface of the slide 4 is a feed arm 6 which, at its front end, is provided with a mounting means 7 for a label holder (not shown) which is intended to receive a label with information relating to the merchandise to be carried by the prong 1. By means of the arm 6 and the mounting means 7, the slide 4 can easily be pulled manually toward the front end of the prong 1 for feeding merchandise on the prong 1. In this connection, the slide 4 is provided with an essentially plane front surface for interaction with the merchandise.

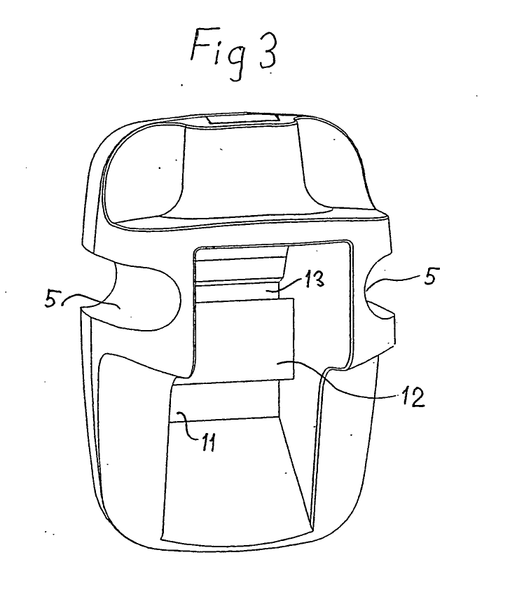

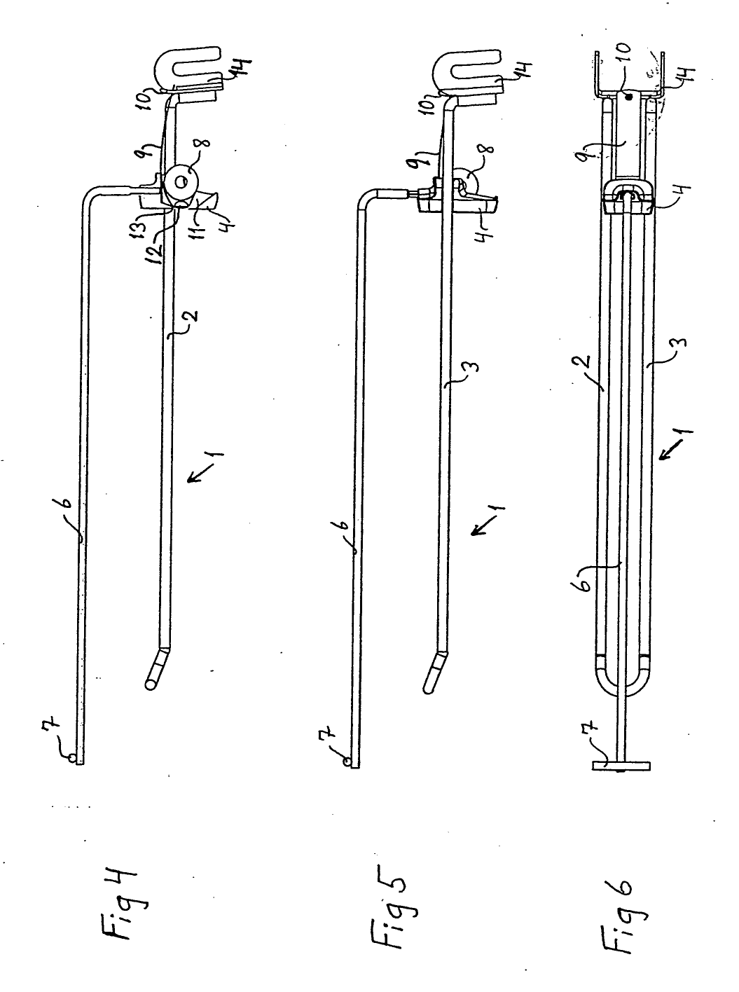

Arranged on the rear side of the feed device 5 is a spring roll 8 (see FIG. 4). The spring 9, which forms the roll 8, can easily be unrolled from the roll in connection with the slide 4 being pulled forward manually. The outer end of the spring is fixed on a pin 10 on the mounting element 14 of the prong. The spring 9 will therefore exert a rearwardly directed tensile force on the slide 4, which tends to return the slide to the inner end position after a completed feed operation. This eliminates the risk of the feed arm 6 remaining in a pulled-out position after it has been released.

It can be seen from FIG. 4 that the spring roll 8 is arranged in a seat on the rear side of the slide 4 (see also FIG. 3). As will become clear below, the roll 8 is held in place in the seat thanks to its own spring force, for which reason no central bearing spindle is necessary. Avoiding the requirement for a bearing spindle is of utmost importance as a construction which is as simple and inexpensive as possible is sought.

In this embodiment, the spring 9 in the roll 8 is unrolled from the lower part of the roll in the direction toward the front end of the prong 1 and passes through a slot 11 to a diverting means made in the form of a bar 12, from which the spring 9, via a second slot 13, extends rearward on the upper side of the roll 8, so that the front end of the spring can be fixed by means of the pin 10. FIGS. 5 and 6 show the arrangement seen from the side and, respectively, from above.

Running the spring 9 in the way shown allows the spring roll 8 to be positioned on the rear side of the slide 4 at the same time as the spring brings about spring-preloading of the entire slide in the rearward direction. This is achieved without using a mounting plate or a bearing spindle for the spring roll, which prevents the coil 8 being pulled rearward. Rather, on account of the spring 9 passing around the bar 12, the coil 8 will be pressed into bearing contact against the inner surface of the bar 12 and other contact surfaces in the seat on the rear surface of the slide 4. The spring roll 8 can therefore be arranged in a loose manner in the seat as it is held in place by pressing against inter alia the bar 12 by virtue of its own spring force.

The bar 12 is suitably located slightly inside the front surface of the slide 4 intended for interaction with the merchandise on the prong 1, so that contact between the spring and this merchandise is avoided.

The embodiment described above can be varied in a number of respects while retaining the principle according to the invention. The spring can thus of course be unrolled in the upper part of the spring roll, instead of in its lower part, and pass down over the bar and back under the spring roll. The bar can also be made and arranged in such a way that the spring can be returned on the same side of the roll as it is removed. The shape of the bar can of course be varied and can be, for example, completely cylindrical. The band-shaped spring shown can be replaced by a wire spring, if this is found to be suitable.

The invention can also be applied in other types of merchandise display prong, for example the type described in our Swedish patent application mentioned above. The design of the slide will then also be changed. The slide can also be made with a solid front surface, the diverting bar then being located inside the seat.

1. An arrangement for merchandise display prongs intended for displaying merchandise, comprising a cantilever arm for carrying the merchandise and a feed device which is displaceable along the arm and provided with a grip part and which is intended, when acted on manually, to displace the merchandise carried by the arm in the forward direction toward its free end for the purpose of bringing about a favorable display of the merchandise, and which feed device is spring-preloaded toward the attachment end of the cantilever arm, characterized in that the arrangement comprises an unrollable spiral spring, in that the spring roll is arranged in a seat on that side of the feed device which faces the attachment end of the arm, in that the spring is adapted so as to be unrolled from the spring roll in the direction toward the free end of the arm and to be diverted around a diverting means located in front of the roll in order to allow attachment of the outer end of the spring to the attachment end of the arm.

2. The arrangement as claimed in claim 1, characterized in that the spring is unrolled from the upper or lower part of the spring roll, and in that, after being diverted, it extends toward the attachment end of the arm on the opposite side of the roll.

3. The arrangement as claimed in claim 1, characterized in that the spring roll is arranged loosely in said seat and is held in place under the action of the spring force.

4. The arrangement as claimed in claim 1, characterized in that said diverting means comprises a transverse bar in an opening in the feed device, which opening is located in front of said seat.

5. The arrangement as claimed in claim 4, characterized in that the front surface of said bar is located slightly inside the front surface of the feed device, which front surface is intended to interact with the merchandise on the arm, in order to avoid contact between the spring and the merchandise.

6. The arrangement as claimed in claim 4, characterized in that the rear surface of said bar constitutes a support surface for the spring roll in its seat.

7. The arrangement as claimed in claim 1, the cantilever arm comprising two essentially parallel wires, characterized in that the feed device is in the form of a slide which is fitted in between the wires and the opposite side surfaces of which are made with guide grooves intended for receiving said wires.

8. The arrangement as claimed in claim 1, characterized in that said grip part extends parallel to and above said arm toward the front end thereof, and in that the front end of the grip part is made with means for mounting a label holder intended to receive a label with information about the merchandise carried by the arm.
